(19) United States
(12) Patent Application Publication
(10) Pub. No.: US 2007/0201660 A1
(43) Pub. Date: Aug. 30, 2007

(54) Method and apparatus for blocking voice call spam

(75) Inventors: Dong Jun Lan, Beijing (CN); Jun Liu, Beijing (CN); Bing Xie, Beijing (CN); Bo Yang, Beijing (CN); Yi Bo Zhang, Beijing (CN)

Correspondence Address: Anne Vachon Dougherty, 3173 Cedar Road, Yorktown Hts, NY, 10598, US

(73) Assignee: International Business Machines Corporation, Armonk, NY (US)

(21) Appl. No.: 11/698,646

(22) Filed: Jan. 26, 2007

(30) Foreign Application Priority Data
Jan. 26, 2006 (CN) 200610003046.4

(51) Int. Cl. H04M 3/42

(52) U.S. Cl. 379/201.01

(57) ABSTRACT

The present invention provides a method and apparatus for determining voice call spam, a method and service server for blocking voice call spam, a voice communication system that has applied the service server and a switch that is used in the voice communication system. The apparatus for determining voice call spam comprises: a pass code generating unit for generating a pass code; a pass code voice generating unit for generating corresponding voice based on said pass code generated by said pass code generating unit; and an acknowledge information receiving unit for receiving acknowledge information from a caller; wherein said voice call is determined as a voice call spam if said acknowledge information from said caller does not contain said pass code.

### FIELD OF THE INVENTION

The present invention relates to the field of communication, and in particular, to the technology of blocking voice call spam in a voice communication system.

### BACKGROUND OF THE INVENTION

Today, with the high speed development of information technology, while people are making full use of the advantages provided by various information networks to obtain information, they also encountered some associated troubles. One main problem that troubles people is the nuisance of spam information. “Spam information” is a term commonly used to refer to the transmission of bulk unwanted unsolicited information. The main objective of spam is that the manufacturers hope to provide direct advertising of their products and services to the largest possible audience at low cost. Over the internet, the notorious email spam has bothered internet users for a long time. Currently, many product and service providers are committing themselves to developing and providing anti-spam products or services for email. Undoubtedly, the solutions will be useful to internet users that hope not to be disturbed by so much email spam. Unfortunately, spam is extending its effect on any system that enables people to communicate with others, and is not limited to email. VoIP (Voice over Internet Protocol) is a group of technologies that provide voice services using Internet protocol in packet networks. While providing voice services to users, it also has the potential of allowing advertisers or service providers to send direct voice communications to target users at low cost. Furthermore, in the Public Switched Telephone Network (PSTN), fixed telephone users will also often suffer from the bother of unwanted commercial advertising calls. In addition, the same is true in amobile communication system, a mobile telephone user will often be interrupted by unwanted commercial calls. Here, the foregoing unwanted commercial voice communications and calls are collectively referred to as voice call spam.

Anti-spam is not a new topic in the IT industry. Currently, there are a series of solutions to deal with spam problems. But most of them are employed to deal with email spam. These technologies can be categorized as the following types:

(1) Content Filtering Technology

Content filtering is achieved by a content filter, which analyzes the content of messages to try to find out whether an email is spam. While this solution is suitable for anti-spam of email, it is not suitable for anti-spam of voice calls, since it is much harder to analyze a voice stream. Further, the user definitely will be disturbed by voice call spam because the call must first be established in order to analyze the voice content.

(2) White List Technology

White list is an address list of calling parties from whom a user is willing to accept calls. This kind of technology has limited benefit on protecting from spam, since a user cannot put all of his/her acceptable calling parties in a white list.

(3) Black List Technology

Black list is an address list of calling parties whom a user identifies as spammers or unwelcome parties. As a white list, it is also a supplementary method. Especially in anti-spam for voice call, it has a big shortcoming in that it cannot recognize and screen advertising producers who have hidden their caller identity to escape from a black list scan.

From the above description it can be seen that the current anti-spam technologies are not suitable for anti-spam of voice call. Therefore, a technology for anti-spam for voice calls is needed in order to enable centralized and effective voice call spam blocking without missing desired voice calls.

### SUMMARY OF THE INVENTION

In view of the above problems in the prior art, the present invention is proposed, the object of which is to provide a method, an apparatus, a service server and a switch, as well as a voice communication system including the service server and switch for centralized voice call spam identifying and blocking in a challenge-response way.

According to one aspect of the invention, there is provided a method for determining voice call spam, comprising: generating a pass code; sending the pass code to a caller in the form of voice; receiving acknowledge information from the caller; and determining that the voice call is voice call spam if the acknowledge information from the caller does not contain the pass code.

According to another aspect of the invention, there is provided a method for blocking voice call spam, comprising: determining whether a voice call is voice call spam by using the method for determining voice call spam; and blocking the voice call if the voice call is determined to be voice call spam.

According to yet another aspect of the invention, there is provided an apparatus for determining voice call spam, comprising: a pass code generating unit for generating a pass code; a pass code voice generating unit for generating corresponding voice based on the pass code generated by the pass code generating unit; and an acknowledge information receiving unit for receiving acknowledge information from a caller; wherein the voice call is determined to be voice call spam if the acknowledge information from the caller does not contain the pass code.

According to yet another aspect of the invention, there is provided a service server, comprising: said apparatus for determining voice call spam; wherein a transferred voice call is blocked when the voice call is determined to be voice call spam.

According to yet another aspect of the invention, there is provided a switch, comprising: a block service triggering database for saving information of users who have subscribed to a voice call spam blocking service; a block service determining means for determining whether the callee of a received voice call has subscribed to the voice call spam blocking service according to the information in the block service triggering database; and a call transferring means for transferring a voice call; wherein the voice call is transferred to a service server when it is determined that the callee of the received voice call has subscribed to the voice call spam blocking service.

According to yet another aspect of the invention, there is provided a voice communication system, comprising: a switch; a voice call spam blocking service server; and a plurality of communication terminals with voice communication capability.

The present invention identifies advertising machines in a challenge-response way to block auto-distributed audio clips, thereby protecting users from being disturbed by voice call spam while not missing real voice calls. The invention will benefit end users by protecting them from voice call spam without screening wanted calls. Further, the invention will benefit telecom operators by providing a new customized service to end users to enhance customer satisfaction and get more revenue.

### BRIEF DESCRIPTION OF THE DRAWINGS

It is believed that the above features, advantages and objectives of the invention will be better understood from the following description of the implementations of the invention taken in conjunction with the accompanying drawings, in which:

FIG. 1 is a structure diagram of the voice communication system according to one embodiment of the invention;

FIG. 2 is a structure diagram of the voice communication system according to another embodiment of the invention;

FIG. 3 is a block diagram that illustrates the structure of the service server according to one embodiment of the invention;

FIG. 4 is a block diagram that illustrates the structure of the voice call spam determination means according to one embodiment of the invention;

FIG. 5 is a block diagram that illustrates the structure of the switch according to one embodiment of the invention;

FIG. 6 is a flowchart that illustrates the method for registering the voice call spam blocking service according to one embodiment of the invention;

FIG. 7 is a flowchart that illustrates the method for determining voice call spam according to one embodiment of the invention; and

FIG. 8 is a flowchart that illustrates the method for blocking voice call spam according to one embodiment of the invention.

### DETAILED DESCRIPTION OF THE INVENTION

Next, various preferred embodiments of the invention will be described in detail in conjunction with the accompanying drawings.

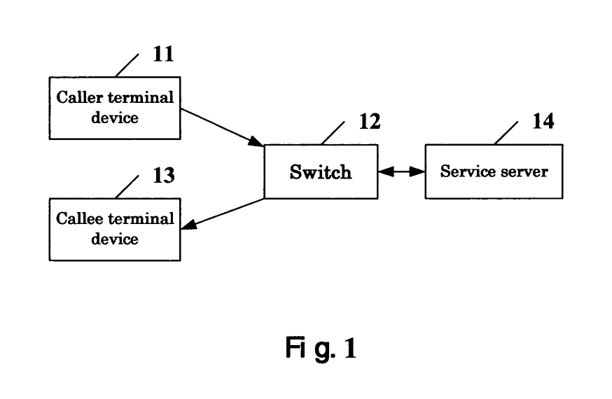

FIG. 1 is a structure diagram of the voice communication system 10 according to one embodiment of the invention. In FIG. 1, caller terminal device 11, switch 12 and callee (or call recipient) terminal device 13 make up a conventional telecommunication system, such as a PSTN system or a mobile communication system. The caller terminal device 11 and the callee terminal device 13 (of course there could be more terminal devices) are coupled to switch 12 respectively. The switch 12 calls the callee terminal device 13 according to a call request coming from the caller terminal device 11. Here, the switch 12 may be an individual device or a switch system formed by a plurality of switches, as is well known to those skilled in the art.

As shown in FIG. 1, the voice communication system 10 of the present embodiment, in addition to the above components, further comprises a service server 14, which is the management part for the voice call spam blocking service. The server is used to receive user's registration to the voice call spam blocking service, to manage user's registration information in a centralized way, and to handle call requests in a centralized way to perform a service for determining voice call spam and blocking voice call spam.

In the embodiment, the switch 12, in addition to the conventional switch's basic capability to perform call routing, further has the capability to cooperate with the service server 14 to provide the voice call spam blocking service. Specifically, the switch 12 also extracts call parameters such as caller ID/callee ID from the caller's call signal, to trigger the voice call spam blocking service according to the call parameters. Specifically, for a call that the callee of which has registered with the service, normal call processing will not be performed, it will be transferred to the service server 14 to determine whether the call is voice call spam, and, when it is determined that the call is voice call spam, the call will further be blocked by the service server 14, as further described in detail below.

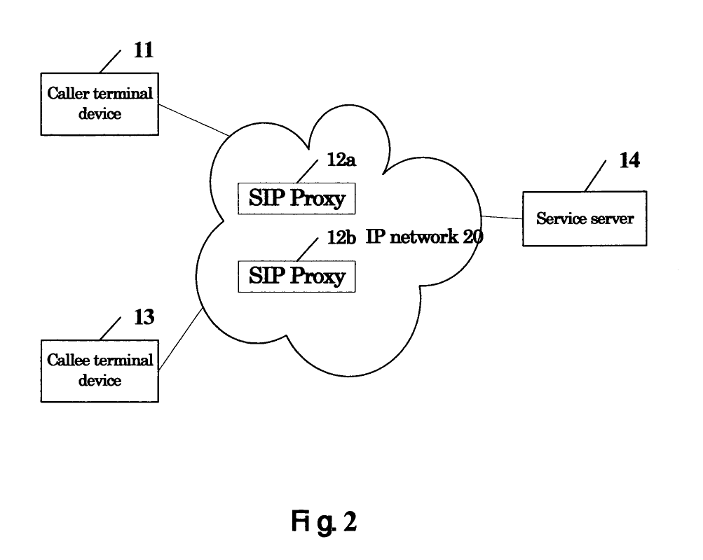

FIG. 2 is a structure diagram of the voice communication system 10 according to another embodiment of the invention. The voice communication system shown in FIG. 2 differs from that in FIG. 1 in that what is shown in FIG. 2 is a telecommunication system based on an IP network 20. In FIG. 2, a caller terminal device 11 and a callee terminal device 13 are VOIP terminals. SIP Proxy 12a, 12b, as switch nodes for handling call requests, have replaced the switch 12 in FIG. 1 (collectively referred to as switch 12 in the following description of the application). Further, the service server 14 is coupled to the IP network 20.

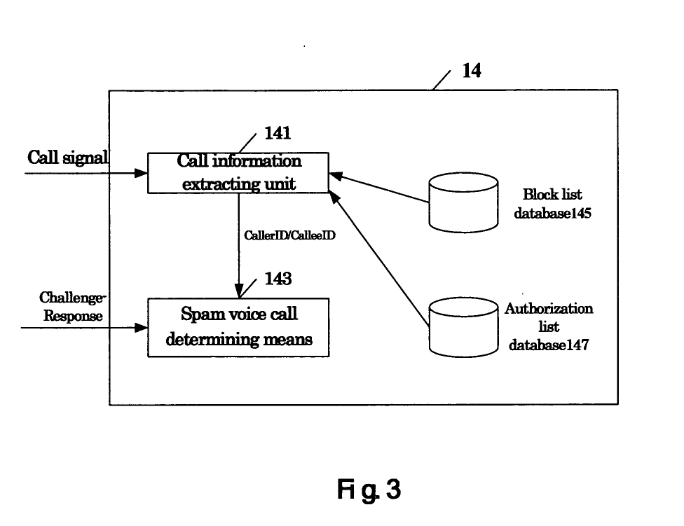

The detailed structure of the service server 14 and switch 12 will be described below in conjunction with FIG. 3-5.

FIG. 3 is a block diagram that illustrates the structure of a service server according to one embodiment of the invention. As shown in FIG. 3, the service server 14 comprises: a call information extracting unit 141 for extracting caller and callee identification information from the call signal; a voice call spam determining means 143 for determining whether a voice call is voice call spam in a challenge-response way and whether to accept or reject that voice call; a block list database 145 for saving block lists set by various callees subscribed to the voice call spam blocking service, wherein the block lists save identity information of callers whose calls can be directly rejected by respective callee without going through a verifying process; an authorization list database 147 for saving authorization lists set by various callees subscribed to the voice call spam blocking service, wherein the authorization lists save identity information of callers whose calls can be directly accepted by the callee without going through a verifying process. Specifically, for a call request transferred from the switch 12, the service server 14 determines whether its caller is in the block list or the authorization list set by the callee. When it is determined that the caller is in the block list, the voice call will be rejected directly. When it is determined that the caller is in the callee's authorization list, the voice call will be permitted and the call request transferred to the callee. When the caller is not in the callee's block list or authorization list, the voice call spam determining means 143 will be determine whether the call is voice call spam.

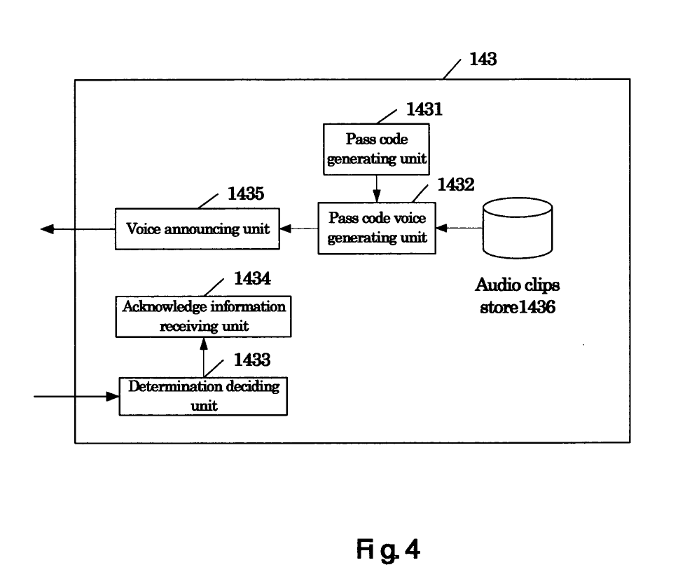

FIG. 4 is a block diagram that illustrates the structure of a voice call spam determining means according to one embodiment of the invention. As shown in FIG. 4, according to one embodiment of the invention, the voice call spam determining means 143 comprises: a pass code generating unit 1431 for generating a pass code, wherein the pass code can be a randomly generated character string or any other authentication information that can achieve the challenge-response purpose; a pass code voice generating unit 1432 for generating corresponding voice according to the pass code generated by the pass code generating unit 1431; a voice announcing unit 1435 for announcing the voice generated by the pass code voice generating unit 1432 to the caller that initiates the call; an acknowledge information receiving unit 1434 for receiving acknowledge information from the caller, wherein, typically, that acknowledge information could be the acknowledge information inputted by the caller in a DTMF way, and the acknowledge information receiving unit 1434 is a DTMF detector for identifying DTMF signal in telephone line; a determination deciding unit 1433 for determining whether the acknowledge information received by the acknowledge information receiving unit 1434 contains the pass code generated by the pass code generating unit 1431, and sending the determination result to the service server 14; and an optional audio clips store 1436 for storing a plurality of audio clips that may be used as background music, as further discussed below. In one preferred embodiment of the invention, the pass code voice generating unit 1432 further adds background music randomly retrieved from the audio clips store 1436 to the generated voice, however, in other embodiments of the invention, background music may not be added to the generated pass code voice, further, in one preferred embodiment of the invention, the pass code voice generating unit 1432 can simply be a voice synthesizer.

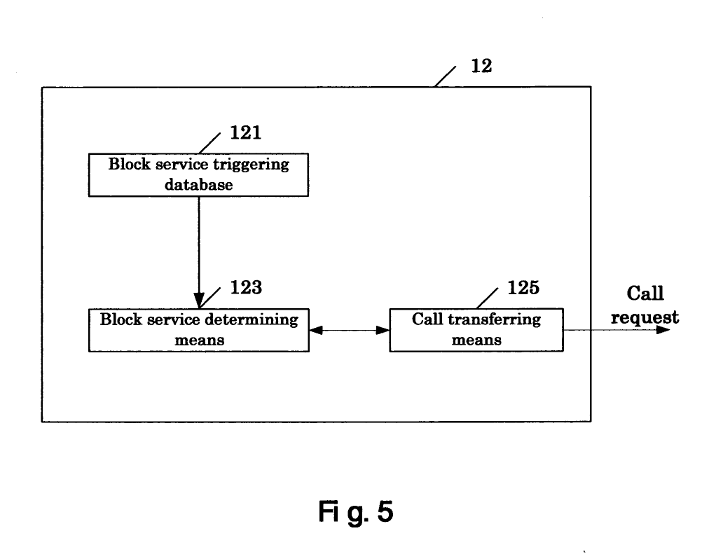

FIG. 5 is a block diagram that illustrates the structure of a switch according to one embodiment of the invention. As shown in FIG. 5, according to one embodiment of the invention, on the basis of a conventional switch, the switch 12 can further comprise: a block service triggering database 121 for saving information (e.g., a user ID) of users who have subscribed the voice call spam blocking service from the service server 14; a block service determining means 123 for determining whether the callee of the received voice call has subscribed to the voice call spam blocking service based on the information in the block service triggering database; a call transferring means 125 for transferring a voice call. The data in the block service triggering database 121 is created and managed by the service server 14, and each time a new user subscribes to the voice call spam blocking service provide by the service server 14, the service server 14 will update the block service triggering database 121 and download it to the switch 12. Specifically, by retrieving the block service triggering database 121 to determine whether the callee ID of a received call request is in the block service triggering database 121, the block service determining means 123 determines whether the callee of the voice call has subscribed to the voice call spam blocking service provided by the service server 14, and when the callee has subscribed to the voice call spam blocking service, the voice call will be transferred by the call transferring means 125 to the service server 14 for processing. Moreover, the switch 12 also has the capability to retrieve call parameters (such as caller ID/callee ID) from the caller's call signal. An example of switch node having the foregoing capability is an enhanced SIP proxy or a conventional telephone switch node etc.

The above-described components in the voice communication system of the embodiment of the invention can be implemented in the form of software or hardware and can be set to be physically separated but operationally interconnected with each other. For example, the voice call spam determining means 143 in the service server 14 of the invention can be implemented by a computer separated from the service server 14, can be implemented as an intelligent peripheral device of the service server 14, or can be implemented in the form of software as a part of the service server 14. Moreover, in the telecommunication system based on an IP network, the functions of the service server 14 can be incorporated into the SIP proxy.

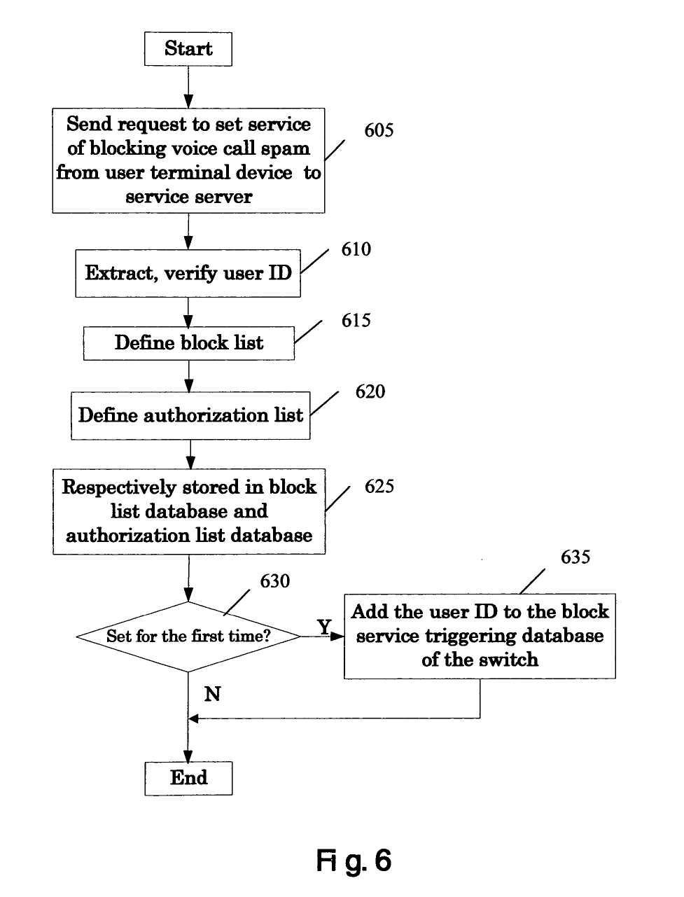

The operational processes of the above voice communication system will be described hereinafter in conjunction with FIG. 6-8.

FIG. 6 is a flowchart of the method for setting the voice call spam blocking service according to one embodiment of the invention. It should be noted that, as a telecommunication value-added service, there are lots of ways to set the voice call spam blocking service, for example, it can be set manually by a system administrator according to user's requirements, which will not influence the implementation of the voice communication system of the invention described hereinbefore and the method for blocking voice call spam described hereinafter. Here, the embodiment shown in FIG. 6 is a method in which a user uses a terminal device to set the voice call spam blocking service through the interaction between the terminal device and service server 14.

As shown in FIG. 6, first at Step 605, a request to set the voice call spam blocking service is sent from a user's terminal device (e.g., 13 in FIG. 1) to the service server 14. Specifically, this can be performed by way of, for example, dialing a particular telephone number.

Next, at Step 610, the service server 14 extracts and verifies the user ID. Specifically, the service server 14 extracts the user ID from the request coming from the user's terminal device and verifies whether the user ID is valid. If the user ID is invalid, the service server 14 can reject the request and end the process (not shown in the figure).

Next, at Step 615, the user is prompted by the service server 14 to complete the definition of the block list. Specifically, the service server 14 can prompt the user by way of voice to enter the ID of the caller whose call could be directly rejected without verification, and the user can send the ID of the caller to be directly rejected to the service server 14 by way of keys. It should be noted that the ID of the caller is the caller's telephone number when the method is applied to the Public Switched Telephone Network, and the ID of the caller is the caller's SIP address when the method is applied to a telecommunication system based on an IP network. It should also be noted that the user can list known advertiser IDs in the block list so that known advertisers' calls can be rejected without going through a verifying process to accelerate the call handling process and improve the handling speed of the call requests.

Next, at Step 620, the user is prompt by the service server 14 to complete the definition of the authorization list. Specifically, the service server 14 can prompt the user by way of voice to enter the ID of the caller whose calls could be directly accepted without verification, and the user can send the ID of the caller to be directly accepted to the service server 14 by way of keys. It should be noted that the ID of the caller is the caller's telephone number when the method is applied to the Public Switched Telephone Network, and the ID of the caller is the caller's SIP address when the method is applied to a telecommunication system based on an IP network. Moreover, it should also be noted that the user can list known IDs of any service providers providing useful free services by way of automatic voice in the authorization list, in order to prevent calls from those IDs from being rejected as voice call spam. Such a free voice service is, for example, a service to remind fixed telephone users to pay the telephone fee in time in the Public Switched Telephone Network.

Next, at Step 625, the user defined block list and authorization list are stored in the block list database 145 and authorization list database 147 in the service server 14, respectively. Optionally, the user setting information and other user information can also be saved as the user profile in the service server 14.

Next, at Step 630, it is determined as to whether the user is setting the voice call spam blocking service for the first time. If “Yes”, such that the user is subscribing to the voice call spam blocking service for the first time, then Step 635 is performed, and the user ID (i.e. the user's telephone number or SIP address) is added into the block service triggering database 121 of the switch 12, thereby keeping data consistency between the switch 12 and service server 14; otherwise, the process ends.

It should be noted that the method of setting the voice call spam blocking service of the present embodiment could also be applicable to the case in which a user performs the setting via a computer network. In addition, when the switch 12 does not have a block service triggering database 121, Step 630 and 635 can be omitted.

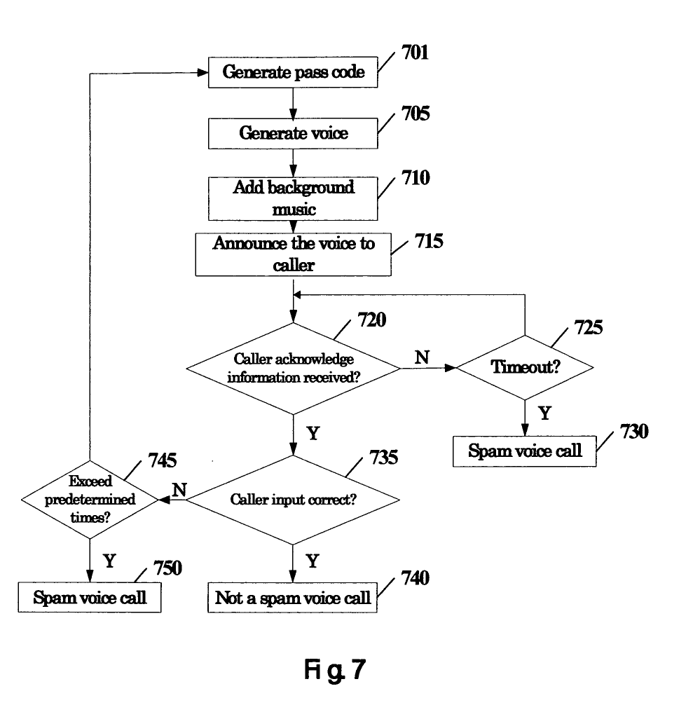

FIG. 7 is a flowchart of the method for determining voice call spam according to one embodiment of the invention. The process shown in FIG. 7 is performed by the voice call spam determining means 143 in the service server 14. As shown in FIG. 7, first at Step 701, a pass code is generated by the pass code generating unit 1431. In one embodiment, the pass code generating unit can be a random number generator and the pass code a random numerical string generated by the random number generator.

Next, at Step 705, the voice corresponding to the pass code is generated. Specifically, the pass code voice generating unit 1432 generates the corresponding pass code voice based on the pass code generated by the pass code generating unit 1431.

Next, at Step 710, background music may be added to the pass code voice generated at Step 705. Specifically, the pass code voice generating unit 1432 can randomly retrieve a segment of audio clip from the audio clips store 1436 as background music and mix it with the generated pass code voice, thereby forming an audio segment. A plurality of audio clips may have been stored previously in the audio clips store by the system administrator.

Next, at Step 715, the mixed voice segment is announced to the caller initiating the call request by using the voice announcing unit, and the caller is prompted to enter the acknowledge information.

At Step 720, the process waits, and as the same time, it is determined whether the acknowledge information of the caller has been received, wherein the acknowledge information can be acknowledge information inputted by the caller in a DTMF way. When it is determined that the acknowledge information of the caller has not been received, then at Step 725, it is determined whether there is a timeout (i.e., whether a preset time period has expired). At Step 725, if the result of the determination is that there is no timeout, then the process returns to Step 720 to continue to wait and to determine whether the acknowledge information of the caller has been received. Steps 720-725 provide a pre-determined waiting time for receipt of acknowledge information from the caller. The length of the pre-determined waiting period can be set by the system administrator.

At Step 725, if it is determined that there is a timeout, then at Step 730, the call is determined as voice call spam, and the service server 14 is notified of the determination.

At Step 720, if it is determined that the acknowledge information of the caller has been received, the process then proceeds to Step 735.

At Step 735, it is determined whether the caller input is correct. Specifically, it is determined whether the acknowledge information inputted by the caller includes the pass code generated by the pass code generating unit 1431 in the audio segment announced to the caller. If it is determined, at Step 735, that the acknowledge information from the caller is incorrect, the process then proceeds to Step 745.

At Step 745, it is determined whether the number of times of incorrect inputs by the caller has exceeded a pre-determined number, for example, 5. The pre-determined number of times can be set by the system administrator. If the number of times of incorrect input by the caller has not exceeded the pre-determined number of times, the process returns to Step 701, and a pass code is regenerated in order to provide the caller with another verification opportunity. If, at Step 745, the pre-determined number of times has been exceeded, then at Step 750, the call is determined to be voice call spam and the service server 14 is notified of that determination.

Returning to Step 735, if it is determined that the acknowledge information from the caller is correct, then at Step 740, it is determined that the voice call is not voice call spam and the service server 14 is notified of that determination.

By utilizing the present embodiment, not only can automatic voice calls be recognized, but also callers can be prevented from automatically recognizing the pass code voice announced to them with voice recognition technology and automatically responding using the recognized voice. The purpose of adding background music is to prevent an automatic voice caller from performing automatic voice recognition on the pass code voice announced to him by using current voice recognition technology, and then automatically providing acknowledge information by using the recognized voice. That is, background music is added to the pass code in the announced audio segment such that an automatic voice caller can not accurately and automatically recognize the pass code therein.

Of course, in another embodiment of the invention, Step 710 in FIG. 7 can be omitted during voice call spam determining, such that background music is not added to the pass code.

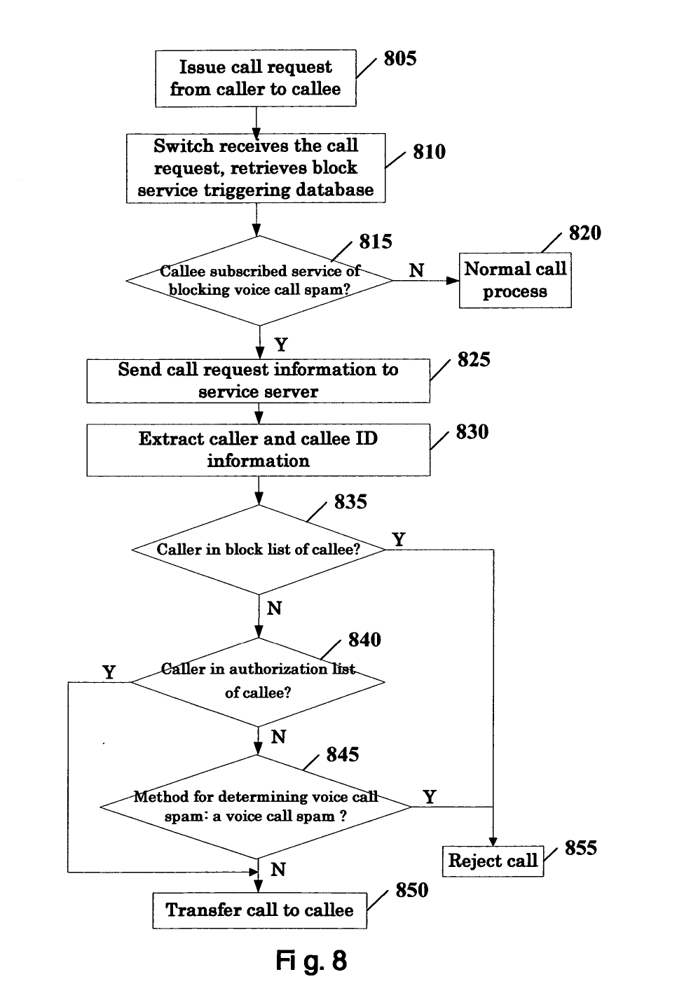

FIG. 8 is a flowchart of the method for blocking voice call spam according to one embodiment of the invention. As shown in FIG. 8, first at Step 805, a call request is sent from a caller to a callee, specifically, this step is performed by the caller user dialing a callee ID via the caller terminal device 11.

Next, at Step 810, the switch 12 receives the call request, obtains callee ID from the call request and retrieves the block service triggering database 121.

At Step 815, it is determined by the switch 12 whether the callee ID is in the block service triggering database 121, that is, whether the callee of the call request has subscribed to the voice call spam blocking service. If “Yes”, the process then proceeds to Step 825, otherwise, to Step 820 to handle it as a normal call request.

As shown above, when the switch 12 (or switch node 12a, 12b) has a block service triggering database 121, the call request is checked against the block service triggering database to determine if the callee ID is recorded in the block service triggering database 121. Only information of call requests whose callees have subscribed to the voice call spam blocking service will be sent to the service server 14 for verification, thereby improving the handling time of the switch 12 and the handling speed.

Of course, the switch 12 may also have no block service triggering database 121 and, for each call request, the switch 12 will need to send the related information to the service server 14 for the determination to be made by the service server 14. In such a case, Step 810-820 can be omitted.

Next, at Step 825, the switch 12 sends the call request information to the service server 14 to perform call transfer. In the present embodiment, the call request information may include the callee ID, caller ID etc.

At Step 830, the service server 14 extracts the caller ID and callee ID from the call request information. In the Public Switched Telephone Network situation, the caller ID and the callee ID are the caller's telephone number and the callee's telephone number respectively. In the telecommunication system based on an IP network, the caller ID and the callee ID are the caller's SIP address and the callee's SIP address respectively.

At Step 835, the service server 14 determines whether the caller is in the block list predefined by the callee according to the extracted caller ID and callee ID. The block list is pre-defined by the callee and lists callers and the callers IDs for callers whose calls can be directly rejected without going through the verifying process.

If it is determined at Step 835 that the caller is on the callee's block list, then at Step 855, the call request is directly rejected by the service server 14.

If it is determined at Step 835 that the caller is not on the callee's block list, the process proceeds to Step 840. At Step 840, the service server 14 determines whether the caller is in the callee's authorization list according to the caller ID and callee ID. The authorization list is pre-defined by the callee and is one listing authorized callers and caller IDs for callers whose call can be directly accepted without going through the verifying process.

If it is determined at Step 840 that the caller is in the callee's authorization list, the process proceeds to Step 850, and the call is transferred to the callee. If it is determined at Step 840 that the caller is not in the callee's authorization list, the process proceeds to Step 845.

At Step 845, the service server 14 determines whether the voice request is voice call spam by using the method for determining voice call spam described above in conjunction with FIG. 7. Since the method is described above in conjunction with FIG. 7, the details will not be repeated herein.

If it is determined by the method for determining voice call spam at Step 845 that the voice call is voice call spam, then at Step 855, the call request is directly rejected by the service server 14. If it is determined at Step 845 that the call is not voice call spam, then at Step 850, the call is transferred to the callee by the service server 14.

From the above description it can be seen that, by utilizing the present embodiment for a user who has subscribed to the voice call spam blocking service of the invention, it can be predetermined whether a call request is voice call spam and voice call spam that is not desired by the callee can be blocked. Moreover, since the invention employs centralized management control, it can be implemented as a value-added service of an operator.

In addition, in another embodiment of the invention, the voice call spam determining means 143 can be installed in the switch 12, whereby the determination on a call request coming from a caller is directly made by the voice call spam determining means 143 in the switch 12, and the switch 12 can decide whether to reject the call request or route it to the callee as a normal call. The embodiment is particularly suitable to the telecommunication system based on an IP network shown in FIG. 2, that is, the VoIP situation. In that case, the SIP proxy 12 comprises a switch node that processes call requests, since the SIP proxy itself is a server that functions as a switch node. Accordingly, the functions of a service server 14 can be incorporated into a SIP proxy 12, thereby saving the cost of additionally setting a service server to provide a voice call spam blocking service. Although the method and apparatus for determining voice call spam, the method, service server and switch for blocking voice call spam, and the voice communication system that has applied the service server and switch of the invention have been described in detail with some illustrative embodiments in the above, these embodiments are not exhaustive, and various changes and modifications may be effected by one skilled in the art within the spirit and scope of the invention. Accordingly, the invention is not limited to these embodiments, rather, the scope of the invention is defined by the appended claims.

1. A method for identifying voice call spam, comprising the steps of:
upon receipt of an incoming call request, generating a pass code;
sending the pass code to a caller in a voice signal;
receiving acknowledge information from said caller; and
identifying the voice call as voice call spam if the acknowledge information from said caller does not contain the pass code.

2. The method for identifying voice call spam according to claim 1, wherein said pass code is one of a random numerical string and a random character string.

3. The method for identifying voice call spam according to claim 1 wherein the step of sending said pass code to a caller in a voice signal comprises the steps of:
generating corresponding voice based on said pass code; and
adding background sound to said corresponding voice.

4. The method for identifying voice call spam according to claim 1, wherein the step of receiving acknowledge information from said caller comprises receiving acknowledge information inputted by said caller in a DTMF way.

5. A method for blocking voice call spam, comprising the steps of:
determining if an incoming call request is voice call spam by:
upon receipt of an incoming call request, generating a pass code;
sending the pass code to a caller in a voice signal;
receiving acknowledge information from said caller; and
identifying the voice call as voice call spam if the acknowledge information from said caller does not contain the pass code; and
blocking the voice call if the voice call is determined to be voice call spam.

6. The method for blocking voice call spam according to claim 5, further comprising:
prior to the step of determining, transferring said voice call to a service server for performing said determining.

7. The method for blocking voice call spam according to claim 6, wherein the step of transferring said voice call to a service server comprises:
extracting callee identification information from said voice call;
determining whether said callee has subscribed to a service for blocking voice call spam; and
transferring said voice call to said service server if said callee has subscribed to the voice call spam blocking service.

8. The method for blocking voice call spam according to claim 7, wherein said service server performs the following steps prior to determining whether said voice call is a voice call spam:
extracting caller and callee identification information from said voice call;
determining whether said caller is in a block list set by said callee, and if yes, blocking said voice call; and
determining whether said caller is in an authorization list set by said callee, and if yes, permitting said voice call.

9. An apparatus for identifying voice call spam, comprising:
a pass code generating unit for generating a pass code in response to receipt of an incoming call request;
a pass code voice generating unit for generating corresponding voice based on said pass code generated by said pass code generating unit; and
an acknowledge information receiving unit for receiving acknowledge information from a caller;
wherein said voice call is determined as voice call spam if said acknowledge information from said caller does not contain said pass code.

10. The apparatus for determining voice call spam according to claim 9, wherein said pass code is one of a random numerical string and a random character string.

11. The apparatus for determining voice call spam according to claim 9, wherein said pass code voice generating unit adds background sound to the generated voice.

12. The apparatus for determining voice call spam according to claim 9, wherein said acknowledge information receiving unit receives acknowledge information inputted by said caller in a DTMF way.

13. A service server, comprising:
apparatus for determining voice call spam a pass code generating unit for generating a pass code in response to receipt of an incoming call request comprising:
a pass code voice generating unit for generating corresponding voice based on said pass code generated by said pass code generating unit; and
an acknowledge information receiving unit for receiving acknowledge information from a caller;
wherein said voice call is determined as voice call spam if said acknowledge information from said caller does not contain said pass code; and
means for blocking said voice call when said voice call is determined to be voice call spam.

14. The service server according to claim 13, further comprising:
a call information extracting unit for extracting caller and callee identification information of said voice call;
a block list database for saving each block list set by respective callee who has subscribed the voice call spam blocking service; and
an authorization list database for saving each authorization list set by respective callee who has subscribed the voice call spam blocking service;
wherein said voice call is blocked when it is determined that the caller of said voice call is in the block list set by said callee;
said voice call is permitted when it is determined that the caller of said voice call is in the authorization list set by said callee.

15. A switch, comprising:
a block service triggering database for saving information of users who have subscribed to voice call spam blocking service;
a block service determining means for determining whether the callee of a received voice call has subscribed to the voice call spam blocking service according to the information in said block service triggering database; and
a call transferring means for transferring a voice call;
wherein said voice call is transferred to a service server when it is determined that said callee of the received voice call has subscribed to the voice call spam blocking service.

16. A voice communication system, comprising:
the switch comprising:
a block service triggering database for saving information of users who have subscribed to voice call spam blocking service;
a block service determining means for determining whether the callee of a received voice call has subscribed to the voice call spam blocking service according to the information in said block service triggering database; and
a call transferring means for transferring a voice call;
wherein said voice call is transferred to a service server when it is determined that said callee of the received voice call has subscribed to the voice call spam blocking service; a service server comprising:
apparatus for determining voice call spam a pass code generating unit for generating a pass code in response to receipt of an incoming call request comprising:
a pass code voice generating unit for generating corresponding voice based on said pass code generated by said pass code generating unit; and
an acknowledge information receiving unit for receiving acknowledge information from a caller;
wherein said voice call is determined as voice call spam if said acknowledge information from said caller does not contain said pass code; and
means for blocking said voice call when said voice call is determined to be voice call spam; and
a plurality of communication terminals with voice communication capability.
